(19) United States
(12) Patent Application Publication
(10) Pub. No.: US 2008/0258623 A1
(43) Pub. Date: Oct. 23, 2008

(54) Low Pressure Discharge Lamp Comprising a Metal Halide

(75) Inventors: Rainer Hilbig, Aachen (DE); Robert Peter Scholl, Roetgen (DE); Achim Gerhard Rolf Koerber, Kerkrade (NL); Johannes Baier, Wurselen (DE); Stefan Schwan, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,256

(22) PCT Filed: May 17, 2005
(86) PCT No.: PCT/IB05/51603

§ 371 Date: Nov. 17, 2006

(30) Foreign Application Priority Data
May 27, 2004 (EP) 04102348.2

(51) Int. Cl. H01J 61/20

(52) U.S. Cl. 313/641

(57) ABSTRACT

A low-pressure gas discharge lamp provided with a gas discharge vessel comprising a gas filling with a discharge-maintaining composition comprising a discharge maintaining compound selected from the group formed by the compounds of aluminum, gallium, indium and thallium, an additive selected from the group of elemental zinc, cadmium and mercury and a buffer gas, which low-pressure gas discharge lamp is further provided with means for generating and maintaining a low-pressure gas discharge.

The invention relates to a low-pressure gas discharge lamp comprising a gas discharge vessel with a gas filling comprising a discharge-maintaining compound selected from the group comprising compounds of gallium, indium and thallium, said low-pressure gas discharge lamp also comprising means for generating and maintaining a low-pressure gas discharge.

Light generation in low-pressure gas discharge lamps is based on the principle that charge carriers, particularly electrons but also ions, are accelerated so strongly by an electric field applied to the gas filling that collisions with the gas atoms or molecules in the gas filling of the lamp cause these gas atoms or molecules to be excited or ionized. When the atoms or molecules of the gas filling return to the ground state, a more or less substantial part of the excitation energy is converted to radiation.

Conventional low-pressure fluorescent gas discharge lamps comprise mercury in the gas filling and, in addition, a phosphor coating on the inside of the gas discharge vessel. A drawback of the mercury low-pressure gas discharge lamps resides in that mercury vapor primarily emits radiation in the high-energy, yet invisible UV-C range of the electromagnetic spectrum, which radiation must first be converted by the phosphors to visible radiation with a much lower energy level. In this process, the energy difference is converted to undesirable thermal radiation.

In addition, the mercury in the gas filling is being regarded more and more as an environmentally harmful and toxic substance that should be avoided as much as possible in present-day mass-products as its use, production and disposal pose a threat to the environment.

It is known already that the spectrum of low-pressure gas discharge lamps can be influenced by substituting the mercury in the gas filling with other substances.

For example, US2002047525 discloses a low-pressure gas discharge lamp provided with a gas discharge vessel containing a gas filling with an indium compound, as the UV emitter, and a buffer gas, which low-pressure gas discharge lamp is also provided with electrodes and means for generating and maintaining a low-pressure gas discharge. This indium-containing low-pressure gas discharge lamp emits in the visible range as well as in the UV range.

It is an object of the invention to provide a low-pressure gas discharge lamp the radiation of which is as close as possible to the visible region of the electromagnetic spectrum and which has improved efficiency and radiation intensity.

In accordance with the invention, this object is achieved by a low-pressure gas discharge lamp provided with a gas discharge vessel comprising a gas filling with a discharge-maintaining composition comprising a discharge-maintaining compound selected from the group formed by the compounds of aluminum, gallium, indium and thallium, an additive selected from the group of elemental zinc, cadmium and mercury and a buffer gas, which low-pressure gas discharge lamp is further provided with means for generating and maintaining a low-pressure gas discharge.

In the lamp in accordance with the invention, a molecular gas discharge takes place at low pressure, which gas discharge emits radiation in the visible and UV region of the electromagnetic spectrum. Apart from the characteristic lines of aluminum, gallium, indium and thallium present in the compounds of aluminum, gallium, indium and thallium, said radiation also includes a broad continuous spectrum in the range from 320 to 450 nm originating from the molecular radiation of the compounds of aluminum, gallium, indium and thallium and resonance radiation originating from the additives selected from the group of elemental zinc, cadmium and mercury.

Possible further additives as well as the internal pressure of the lamp and the operating temperature enable the exact position and spectral distribution of the continuous spectrum and the plasma efficiency to be controlled.

In combination with phosphors, the lamp in accordance with the invention has a visual efficiency and radiation intensity, which are substantially higher than those of conventional low-pressure mercury discharge lamps. The visual efficiency, expressed in lumen/Watt, is the ratio between the brightness of the radiation in a specific visible wavelength range and the energy for generating the radiation. The high visual efficiency of the lamp in accordance with the invention means that a specific quantity of light is obtained at a smaller power consumption. Besides, the use of mercury is avoided.

As an UV-A lamp, the lamp in accordance with the invention is advantageously used as a tanning lamp, or as a disinfecting lamp or as a lacquer-curing lamp. For general illumination purposes, the lamp may be combined with appropriate phosphors. As the losses caused by Stokes' displacement are small, visible light having a high luminous efficiency is obtained.

Within the scope of the invention it may be especially preferred that the discharge-maintaining compound is selected from the group formed by the halides of aluminum, gallium, indium and thallium.

The gas filling may further comprise a halide selected from the halides of zinc, cadmium and mercury.

The gas filling may further comprise an elemental metal selected from the group made up of aluminum, gallium, indium and thallium. The gas filling may further comprise an elemental metal selected from the group made up of zinc, cadmium and mercury.

An inert gas which is particularly contemplated for use as a buffer gas is selected from the group formed by helium, neon, argon, krypton and xenon.

Advantageously, the gas pressure of the inert gas at the operating temperature at nominal operation ranges from 0.1 to 100 mbar, with 2 mbar being the preferred value.

In the description and the claims of the present invention, the designation “nominal operation” is used to indicate operational conditions in which the vapour pressure of the discharge-maintaining composition is such that the radiant efficiency of the lamp is at least 80% of the maximum radiant efficiency of that lamp, i.e. operating conditions in which the pressure of the radiating species is optimal.

Within the scope of the invention it may be preferred that the gas discharge vessel comprises a phosphor coating on the inside or outside surface of the wall.

A low-pressure discharge lamp according to the invention may comprise means for generating a low-pressure gas discharge, which are selected from the means comprising an inner electrode, an outer electrode and electrodeless means.

In a low-pressure gas discharge lamp according to the invention the gas discharge vessel may comprise a heat-reflective coating.

These and other aspects of the invention will be apparent from and elucidated with reference to a drawing and 6 embodiments.

### DETAILED DESCRIPTION

In an embodiment of the invention as shown in FIG. 1, the low-pressure gas discharge lamp in accordance with the invention is composed of a tubular lamp bulb 1, which surrounds a discharge space. At both ends of the tube, inner electrodes 2 are sealed in, via which electrodes the gas discharge can be ignited. The low-pressure gas discharge lamp comprises a lamp holder and a lamp cap 3. An electrical ballast is integrated in known manner in the lamp holder or in the lamp cap, which ballast is used to control the ignition and the operation of the gas discharge lamp. In a further embodiment, not shown in FIG. 1, the low-pressure gas discharge lamp can alternatively be operated and controlled via an external ballast.

The gas discharge vessel may alternatively be embodied so as to be a multiple-bent or coiled tube surrounded by an outer bulb. The wall of the gas discharge vessel is preferably made of a glass type which is transparent to UV-A radiation of a wavelength between 320 and 400 nm, quartz or a transparent ceramic, such as aluminum oxide.

For the gas filling use is made, in one embodiment, of a halide selected from the halides of aluminum, gallium, indium and thallium in a quantity of 2×10⁻¹¹ mole/cm³ to 2×10⁻⁸ mole/cm³ and an inert gas. The inert gas serves as a buffer gas enabling the gas discharge to be more readily ignited. For the buffer gas use is preferably made of argon. Argon may be substituted, either completely or partly, with another inert gas, such as helium, neon, krypton or xenon.

The plasma efficiency can be dramatically improved in comparison with the prior art lamp by adding an additive selected from the group formed by elemental zinc, cadmium and mercury to the gas filling. The efficiency can also be improved by combining two or more compounds in the gas atmosphere.

The efficiency can be further improved by optimizing the internal pressure of the lamp during operation. The cold filling pressure of the buffer gas is maximally 100 mbar. Preferably, said pressure lies in a range between 1.0 and 5.0 mbar, more preferably at 2.0 mbar.

It has been found that an increase of the lumen efficiency of the low-pressure gas discharge lamp can be achieved by controlling the operating temperature of the lamp by means of suitable constructional measures. The diameter and the length of the lamp are chosen to be such that, during operation at an outside temperature of 25° C., an inside temperature in the range from 140° C. to 290° C. is attained. This inside temperature relates to the coldest spot of the gas discharge vessel as the discharge brings about a temperature gradient in the vessel.

To increase the inside temperature, the gas discharge vessel may also be coated with an infrared radiation-reflecting coating. Preferably, use is made of an infrared radiation-reflecting coating of tin oxide.

A low-pressure gas discharge lamp according to the invention may comprise means for generating and maintaining a low pressure discharge comprising inner electrodes or outer electrodes or electrode less means.

A suitable material for the electrodes in the low-pressure gas discharge lamp in accordance with the invention comprises, for example, nickel, a nickel alloy or a metal having a high melting point, in particular tungsten and tungsten alloys. Also composite materials of tungsten with thorium oxide or zinc oxide can suitably be used. By providing emitter material on the electrode the work function of the electrode can be further reduced.

In the embodiment in accordance with FIG. 1, the inside surface of the gas discharge vessel 4 of the lamp is coated with a phosphor layer 4′. The UV-radiation originating from the gas discharge excites the phosphors in the phosphor layer so as to bring about light emission in the visible region 5.

The chemical composition of the phosphor layer determines the spectrum of the light or its tone. The materials that can suitably be used as phosphors must absorb the radiation generated and emit said radiation in a suitable wavelength range, for example for the three basic colors red, blue and green, and enable a high fluorescence quantum yield to be achieved.

Suitable phosphors and phosphor combinations must not necessarily be applied to the inside of the gas discharge vessel; they may alternatively be applied to the outside of the gas discharge vessel as the customary glass types do not absorb UV-A radiation.

In accordance with another embodiment, the lamp is capacitively excited using a high frequency field, the electrodes being provided on the outside of the gas discharge vessel.

In accordance with a further embodiment, the lamp is inductively excited by means of a high frequency field or a microwave arrangement using inductive coils or a high frequency antenna.

When the lamp is ignited, the electrons emitted by the electrodes excite the atoms and molecules of the gas filling so as to emit radiation.

The discharge heats up the gas filling such that the desired vapor pressure and the desired operating temperature ranging from 200° C. to 300° C. is achieved at which the light output is optimal.

The radiation generated during operation from the gas filling comprising compounds of aluminum, gallium, indium and thallium as well as an additive selected from the group comprising elemental zinc, cadmium and mercury, exhibits the characteristic line spectrum of the elementary aluminum, gallium, indium and thallium present in the compounds as well as the characteristic line spectrum of the elements zinc, cadmium and mercury.

Apart from the characteristic line emission of the elements, the gas filling emits an intensive, wide continuous molecular spectrum between 320 and 450 nm, which is brought about by molecular discharge of the compounds of aluminum, gallium, indium and thallium. The maximum emission range of the continuous molecular spectrum shifts to longer wavelengths as the molecular weight of the halide increases.

### EXAMPLE 1

A cylindrical discharge vessel of quartz, having a length of 25 cm and a diameter of 2.5 cm, is provided with outer electrodes of copper. The discharge vessel is evacuated and simultaneously a dose of 0.1 mg gallium chloride and 0.2 mg zinc is added. Also argon is introduced at a cold pressure of 2.5 mbar. A high frequency field having a frequency of 13.5 MHz is supplied from an external source and, at an operating wall temperature of 270° C., a maximum in plasma efficiency is measured.

In FIG. 2 the emission spectrum is shown, comprising blue Ga-lines at 403 nm and 417 nm, the UV-lines of Ga at 288 nm and 294 nm, the broadband emission of gallium chloride as well as the UV resonance lines of zinc at 214 nm and 308 nm and the emission in the visible at 468 nm, 472 nm and 481 nm.

### EXAMPLE 2

A cylindrical discharge vessel of quartz, having a length of 25 cm and a diameter of 2.5 cm, is provided with outer electrodes of conductive material. The discharge vessel is evacuated and simultaneously a dose of 0.1 mg indium chloride and 0.1 mg zinc is added. Also argon is introduced at a cold pressure of 2.5 mbar. A high frequency field having a frequency of 13.5 MHz is supplied from an external source and, at an operating wall temperature of 287° C., a maximum in plasma efficiency is measured.

In FIG. 3 the emission spectrum is shown, comprising blue In-lines at 410 nm and 451 nm, the UV-lines of In at 326 nm and between 250 nm and 300 nm, the broadband emission of indium chloride between 340 nm and 380 nm as well as the UV resonance lines of zinc at 214 nm and 308 nm and the emission in the visible at 468 nm, 472 nm and 481 nm.

### EXAMPLE 3

A cylindrical discharge vessel of quartz, having a length of 25 cm and a diameter of 2.5 cm, is provided with outer electrodes of conductive material. The discharge vessel is evacuated and simultaneously a dose of 0.12 mg indium bromide and 0.1 mg zinc is added. Also argon is introduced at a cold pressure of 2.5 mbar. A high frequency field having a frequency of 13.5 MHz is supplied from an external source and, at an operating wall temperature of 287° C., a maximum in plasma efficiency is measured.

In FIG. 4 the emission spectrum is shown, comprising blue In-lines at 410 nm and 451 nm, the UV-lines of In at 326 nm and between 250 nm and 300 nm, the broadband emission of indium bromide between 355 nm and 395 nm as well as the UV resonance lines of zinc at 214 nm and 308 nm and the emission in the visible at 468 nm, 472 nm and 481 nm.

### EXAMPLE 4

A cylindrical discharge vessel of glass, which is transparent to UV-A radiation, having a length of 25 cm and a diameter of 2.5 cm, is provided with outer electrodes of conductive material. The discharge vessel is evacuated and simultaneously a dose of 0.2 mg indium bromide, 0.05 mg mercury bromide and 0.2 mg indium is added. Also argon is introduced at a cold pressure of 2.5 mbar. A high frequency field having a frequency of 13.5 MHz is supplied from an external source and, at an operating wall temperature of 228° C., a maximum in plasma efficiency is measured.

In FIG. 5 the emission spectrum is shown, comprising blue In-lines at 410 nm and 451 nm, the UV-lines of In at 326 nm and between 250 nm and 300 nm, the broadband emission of indium bromide between 355 nm and 395 nm as well as the intercombination line of mercury at 254 nm and the emission in the visible at 405 nm, 436 nm and 546 nm.

### EXAMPLE 5

A cylindrical discharge vessel of glass, which is transparent to UV-A radiation, having a length of 25 cm and a diameter of 2.5 cm, is provided with outer electrodes of conductive material. The discharge vessel is evacuated and simultaneously a dose of 0.1 mg indium iodide and 0.1 mg cadmium is added. Also argon is introduced at a cold pressure of 2.5 mbar. A high frequency field having a frequency of 13.5 MHz is supplied from an external source and, at an operating wall temperature of 260° C., a maximum in plasma efficiency is measured.

In FIG. 6 the emission spectrum is shown, comprising blue In-lines at 410 nm and 451 nm, the UV-lines of In at 326 nm and between 250 nm and 300 nm, the broadband emission of indium iodide at 400 nm as well as the intercombination line of cadmium at 326 nm and 229 nm and the emission in the visible at 477 nm, 480 nm and 509 nm.

### EXAMPLE 6

A cylindrical discharge vessel of glass, which is transparent to UV-A radiation, having a length of 25 cm and a diameter of 2.5 cm, is provided with outer electrodes of conductive material. The discharge vessel is evacuated and simultaneously a dose of 0.1 mg indium chloride and 0.1 mg cadmium is added. Also argon is introduced at a cold pressure of 2.5 mbar. A high frequency field having a frequency of 13.5 MHz is supplied from an external source and, at an operating wall temperature of 279° C., a maximum in plasma efficiency is measured.

In FIG. 7 the emission spectrum is shown, comprising blue In-lines at 410 nm and 451 nm, the UV-lines of In at 326 nm and between 250 nm and 300 nm, the broadband emission of indium chloride between 340 nm and 380 nm as well as the intercombination line of cadmium at 326 nm and the allowed resonance line at 229 nm and the emission in the visible at 477 nm 480 nm and 509 nm.

FIG. 6 also shows the less intense emission of a lamp comprising indium chloride without an additive as disclosed by this invention.

### DESCRIPTION OF THE DRAWINGS

In the drawings:

FIG. 1 shows diagrammatically the light generation in a low-pressure gas discharge lamp comprising a gas filling containing an indium(I) compound plus elemental zinc.

FIG. 2 shows the emission spectrum of a low-pressure gas discharge lamp comprising a gas filling containing gallium chloride and zinc.

FIG. 3 shows the emission spectrum of a low-pressure gas discharge lamp comprising a gas filling containing indium chloride and zinc.

FIG. 4 shows the emission spectrum of a low-pressure gas discharge lamp comprising a gas filling containing indium bromide and zinc.

FIG. 5 shows the emission spectrum of a low-pressure gas discharge lamp comprising a gas filling containing indium bromide, mercury bromide and mercury.

FIG. 6 shows the emission spectrum of a low-pressure gas discharge lamp comprising a gas filling containing indium iodide and cadmium

FIG. 7 shows the emission spectrum of a low-pressure gas discharge lamp comprising a gas filling containing indium chloride and cadmium.

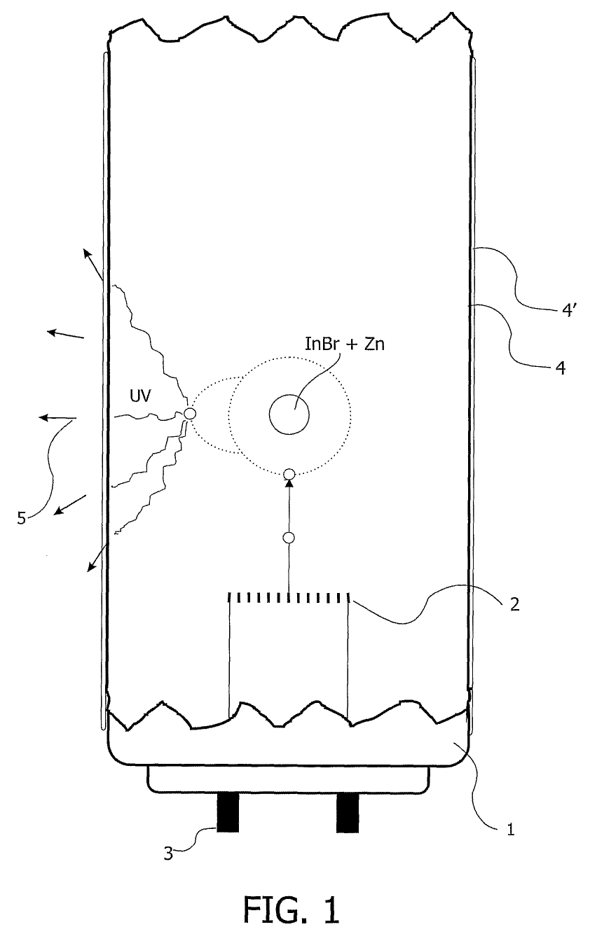

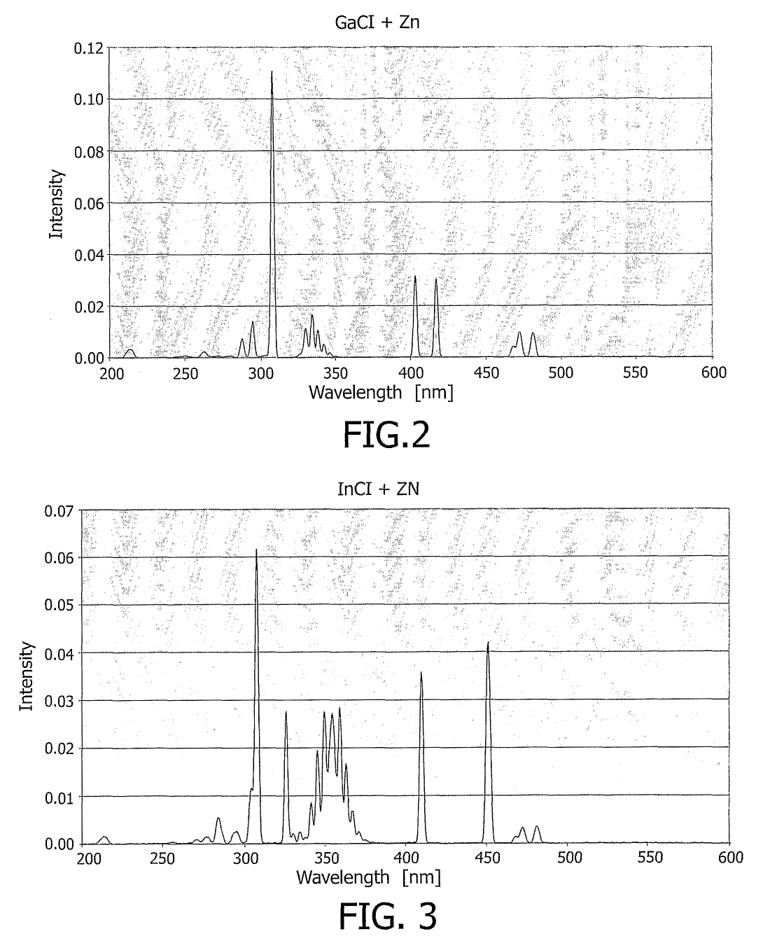

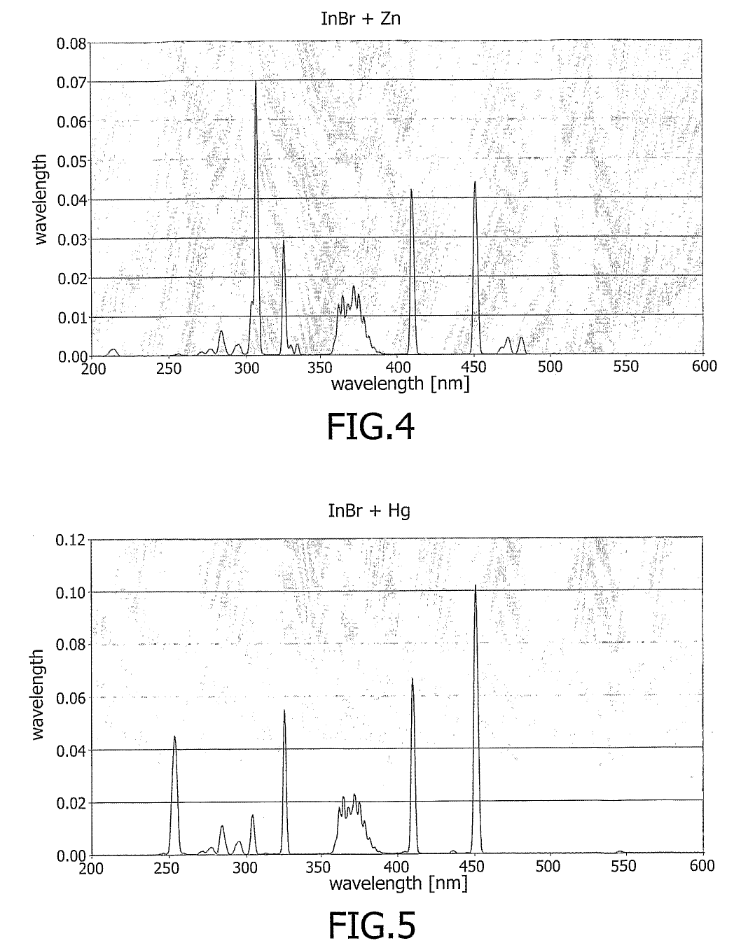

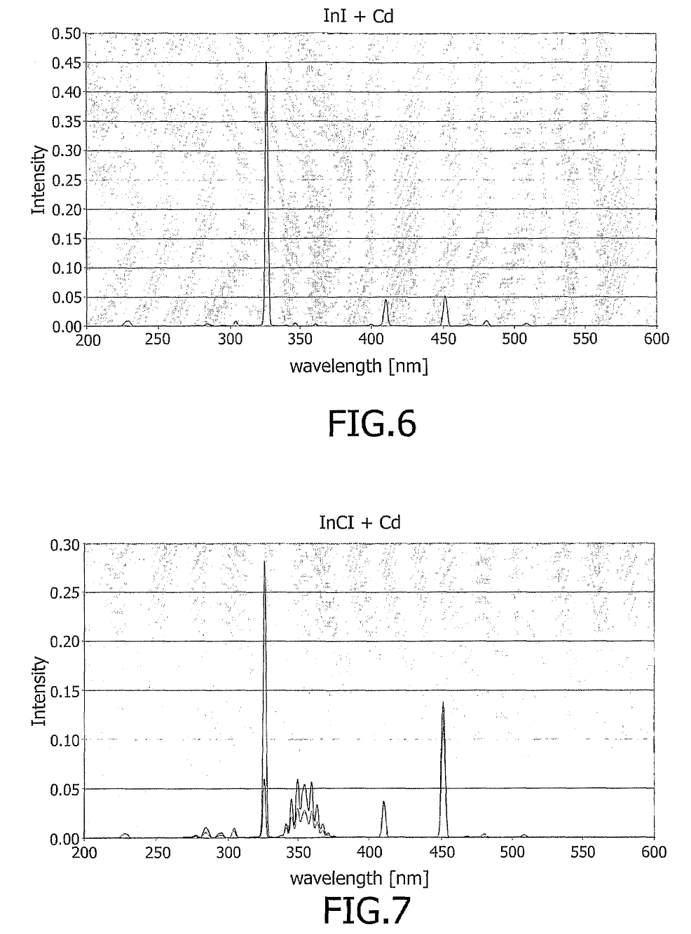

1. A low-pressure gas discharge lamp provided with a gas discharge vessel comprising a gas filling with a discharge-maintaining composition comprising a discharge-maintaining compound selected from the group formed by the compounds of aluminum, gallium, indium and thallium, an additive selected from the group of elemental zinc, cadmium and mercury and a buffer gas, which low-pressure gas discharge lamp is further provided with means for generating and maintaining a low-pressure gas discharge.

2. A low-pressure gas discharge lamp as claimed in claim 1, wherein the discharge maintaining compound is selected from the group formed by the halides of aluminum, gallium, indium and thallium.

3. A low-pressure gas discharge lamp as claimed in claim 1, characterized in that the gas filling further comprises a halide selected from the halides of zinc, cadmium and mercury.

4. A low-pressure gas discharge lamp as claimed in claim 1, characterized in that the gas filling further comprises an elemental metal selected from the group of aluminum, gallium, indium and thallium.

5. A low-pressure gas discharge lamp as claimed in claim 1, characterized in that the gas filling further comprises an elemental metal selected from the group of zinc, cadmium and mercury.

6. A low-pressure gas discharge lamp as claimed in claim 1, wherein the gas filling comprises, as a buffer gas, an inert gas selected from the group formed by helium, neon, argon, krypton and xenon.

7. A low-pressure gas discharge lamp as claimed in claim 5, wherein the gas filling comprises, as a buffer gas, an inert gas selected from the group formed by helium, neon, argon, krypton and xenon, and the gas pressure of the inert gas at the operating temperature at nominal operation ranges below 100 mbar.

8. A low-pressure gas discharge lamp as claimed in claim 1, characterized in that the gas discharge vessel comprises a phosphor coating.

9. A low-pressure gas discharge lamp as claimed in claim 1, characterized in that the means for generating a low-pressure gas discharge are selected from the means comprising an inner electrode, an outer electrode and electrodeless means.

10. A low-pressure gas discharge lamp as claimed in claim 1, characterized in that the gas discharge vessel comprises an infrared-reflective coating.
